(19) United States
(12) Patent Application Publication
(10) Pub. No.: US 2012/0120059 A1
(43) Pub. Date: May 17, 2012

(54) DISPLAY FOR 3D HOLOGRAPHIC IMAGES

(76) Inventors: Alexandre Bratkovski, Mountain View, CA (US); Lars Thylen, Palo Alto, CA (US); Jinging Li, Palo Alto, CA (US)

(21) Appl. No.: 13/259,191

(22) PCT Filed: Oct. 27, 2009
(86) PCT No.: PCT/US09/62210

§ 371 Date: Sep. 23, 2011

(51) Int. Cl. G06T 15/00

(52) U.S. Cl. 345/419

(57) ABSTRACT

A display device for displaying 3D holographic images has multiple pixels, each having a set of coupled optical resonators. The optical paths of the coupled optical resonators can be adjusted to impart a desired phase shift to light passing through the coupled optical resonators. The transmission amplitude and phase of each pixel of the display can be dynamically and individually adjusted for displaying 3D holographic images.

### BACKGROUND

Holography is a technique that allows the creation of a virtual image of objects that appear three-dimensional (3D) to a viewer. The perception of seeing 3D objects significantly enhances the realism of the viewing, and such realism can be highly desirable for video displays for various purposes such as entertainment and training. Nevertheless, while holography is commonly used in the form of holograms to display static 3D images, there has been no viable technology available for displaying dynamically changing holographic images as a part of a video or computer generated graphics.

### BRIEF DESCRIPTION OF THE DRAWINGS

Some embodiments of the invention are described, by way of example, with respect to the following figures:

FIG. 1 is a schematic depiction of a display system for displaying 3D holographic images;

FIG. 2 is a schematic perspective view of a portion of a display device constructed in accordance with an embodiment of the invention for generating 3D holographic images;

FIG. 3 is an exploded view of a pixel of the display device of FIG. 2;

FIG. 4A is a schematic depiction of an optical resonator;

FIG. 4B is a plot of the transfer function of the optical resonator of FIG. 4A;

FIG. 4C is a schematic depiction of two or more coupled optical resonators;

FIG. 4D is a plot of the transfer function of the coupled optical resonators of FIG. 4C;

FIG. 5 is a plot of the transmission amplitude and phase curves of a set of coupled optical resonators under three different operating conditions; and

FIG. 6 is a schematic view of a pixel of a display device of an embodiment of the invention for generating color holographic images.

### DETAILED DESCRIPTION

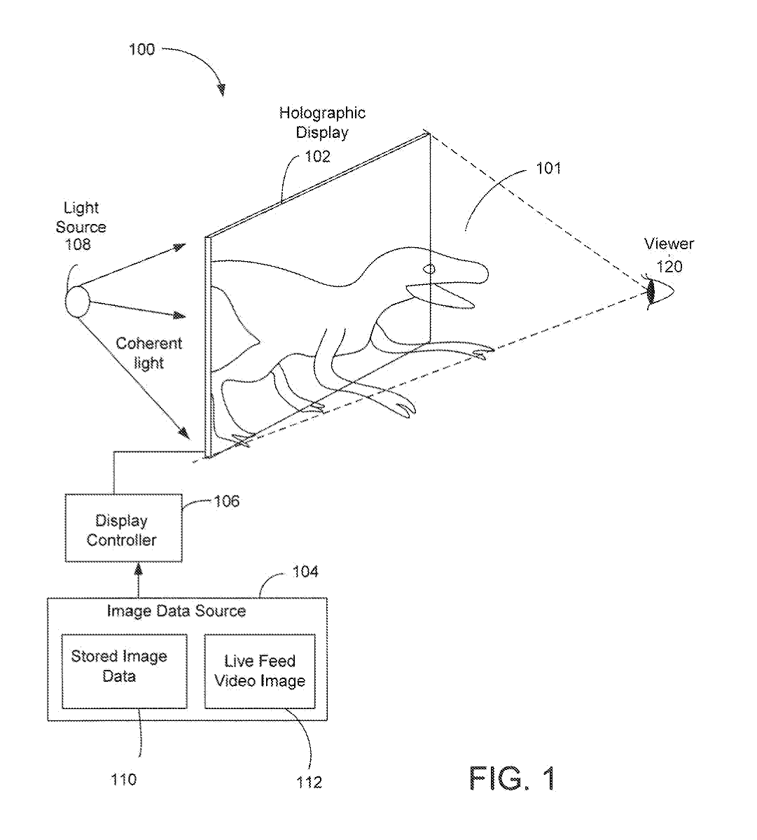

FIG. 1 shows a display system 100 of an embodiment of the invention that is capable of displaying 3-dimensional (3D) holographic images 101. A significant advantage of this display system 100 is that it is capable of displaying dynamically changing images, such as video images or computer-generated graphics for computer games, in a 3D holographic format and at a high resolution. As illustrated in FIG. 1, the system includes a display device 102, an image data source 104, and a controller 106. The image data source 104 provides data containing information of the holographic images to be displayed by the display device 102. The image data may come from a storage device 110 on which the data is stored, or come from a live video feed 112. The image data may be computer generated in real time, for example by a computer game, rather than being a recording of real events. The controller 106 receives the image data and controls the operation of the display device 102 to generate the 3D holographic images for viewing by a viewer 120. The display system 100 may include a light source 108 for generating a coherent light needed for illuminating the display device 102 to generate the holographic images.

Generally, a holographic image 101 that gives a viewer 120 the impression of seeing 3D objects has not only amplitude variations but also phase variations in the light constituting the image. As will be described in greater detail below, embodiments of the present invention provide controls of the phase variation as well as the amplitude variation on a pixel level and at a high speed to enable the generation of dynamically changing high-resolution holographic images.

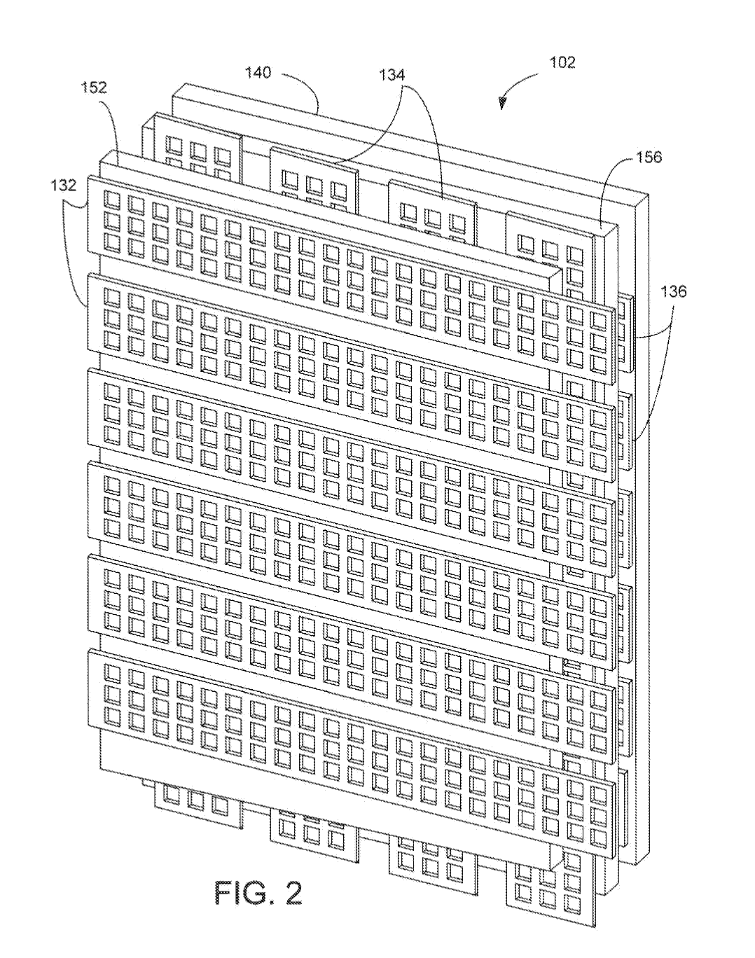

FIG. 2 shows the construction of an embodiment of the display device 102. In this embodiment, the display device 102 utilizes a crossbar structure that is simple and compact. The crossbar structure includes a first group of generally parallel electrodes 132 in a first layer, a second group of generally parallel electrodes 134 in a second layer, and a third group of generally parallel electrodes 136 in a third layer, with the second layer disposed between the first and third layers. The electrodes 132, 136 in the first and third layers extend in a first direction, and the electrodes 134 in the second layer extend in a second direction that is at an angle from the first direction. In the illustrated embodiment, the angle is 90 degrees, i.e., the electrodes in the first and third layers are orthogonal to the electrodes in the second layer. Nevertheless, an angle other than 90 degrees may be used depending on the design of the display device.

Due to their different orientations, the electrodes 132, 136 in the first and third layers intersect with the electrodes 134 in the second layer and form a two-dimensional matrix of intersections. Each of the intersections may define a pixel or sub-pixel of the display. As described in greater detail below, a set of coupled optical resonators may be formed at each intersection to provide the functionality of imparting a desired phase angle to light coming through the pixel. The display device 102 may further include a layer 140 for controlling the amplitude of the light generated by the pixel. For instance, the amplitude control layer 140 may contain a matrix of LCD's, with each LCD controlling the attenuation of light passing through a pixel or sub-pixel. As described below, the phase angle control and the amplitude control are largely decoupled so that the two can be adjusted separately. This allows adjustment of the light intensity, phase, and color of each pixel independently from the other pixels, thus enabling the display of different holographic 3D images.

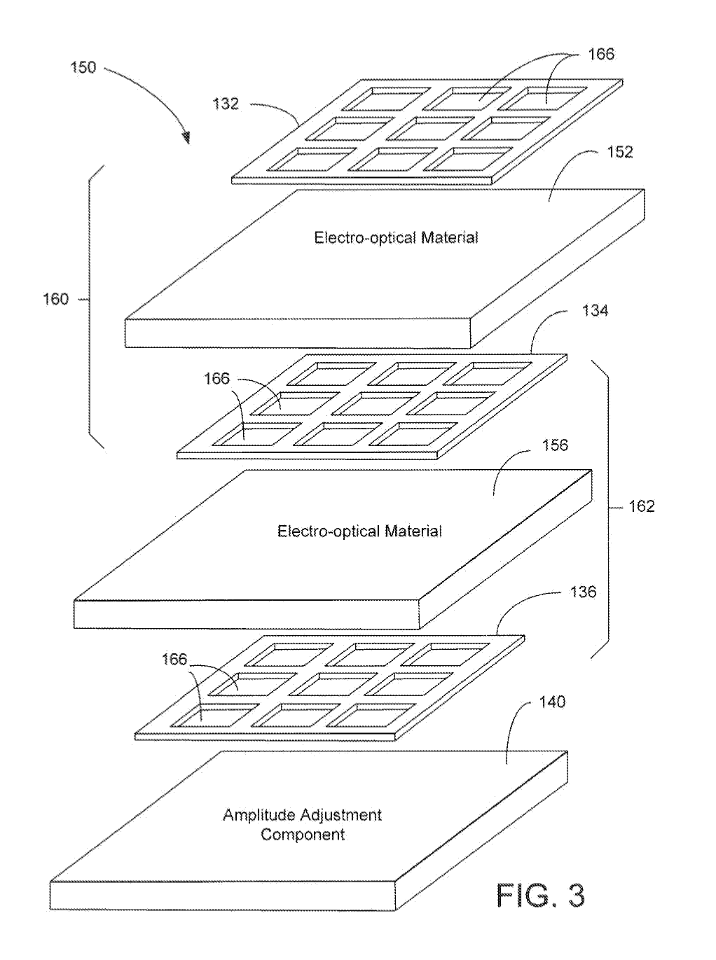

FIG. 3 shows, in an exploded view, a display pixel or sub-pixel 150 constructed in accordance with an embodiment of the invention. In this illustrated embodiment, there are two coupled optical resonators. A first layer 152 of an electro-optical material is disposed between a first electrode 132 and a second electrode 134, and together they form a first optical resonator 160. A second layer 156 of the electro-optical material is disposed between the second electrode 134 and a third electrode 136, and together they form a second optical resonator 162. In this regard, each electrode functions as a light reflector for the resonator of which it is a part. To this end, in some embodiments the electrodes may be formed of a metal, such as gold, silver or aluminum.

To allow light to transmit into and out of the resonators 160 and 162, each electrode has apertures 166 or openings formed therein. The size of the apertures 166 and the separations between them may be set to optimize a balance between the light transmission and resonance of the resonators. In some embodiments, the pitch of the apertures may be around ⅕ or ⅙ of the wavelength of the light that will be transmitted through the resonators, and the width of the aperture may be about 60%-65% of the pitch. For instance, if the light to be modulated by the pixel or sub-pixel 150 is red with a wavelength around 650 nm, then the pitch of the apertures may be around 120 nm, and the aperture width may be around 75 nm. The thickness of the electrodes in some embodiments may be smaller than the width of the apertures and may be, for example, about 20 nm. The width of the electrodes, which defines the dimensions of the optical resonators, may be chosen for the desired pixel size. In some embodiments, as illustrated in FIG. 3, there may be multiple apertures in the electrodes for one optical resonator. It should be noted that the width of each of the electrodes forming the optical resonators may be smaller than the wavelength of the light to be modulated. Thus, the size of each pixel of the display may be smaller than the light wavelength, thereby providing a sub-wavelength spatial resolution.

The electro-optical material forming the two optical resonators is a type of material that has one or more optical properties modifiable by the application of an electrical field. In embodiments of this invention, the optical path lengths of the optical resonators are tuned by the application of voltages to the electrodes 132, 134, and 136 to create electrical fields across the resonators 160 and 162. The tuning of the optical path lengths may be done, for instance, by altering the index of refraction of the electro-optical material. Suitable materials with this property include, for example, LiNbO₃, PbLaZrTiO₃, LiTaO₃, III-V compound semiconductors such as GaAs, AlAs, GaP, InP and their compounds. Of these semiconductors, only AlAs and GaP are transparent in the visible. The suitable materials also include II-VI compound semiconductors such as CdSe, CdS, CdTe, ZnSe, ZnS, ZnTe, and their compounds. Further, material phase change materials such as chalcogenides could be used. Material phase change chalcogenides are heat driven and by applying the heat from a voltage or current source, the entire layer will undergo a phase change and thus produce a large change in the refractive index. These materials can thus be chalcogenide glasses which are a group of bandgap semiconductor materials containing one or more chalcogens, such as sulfur (“S”), selenium (“Se”), and tellurium (“Te”), in combination with relatively more electropositive elements, such as arsenic (“As”), germanium (“Ge”), phosphorous (“P”), antimony (“Sb”), bismuth (“Bi”), silicon (“Si”), tin (“Sn”), and other electropositive elements. Examples of chalcogenide glasses that can be used include GeSbTe, GeSb₂Te₄, InSe, SbSe, SbTe, InSbSe, InSbTe, GeSbSe, GeSbSeTe, AgInSbTe, AgInSbSeTe, and AsₓSe₁₋ₓ, AsₓS₁₋ₓ, and As.₄₀S.₆₀₋ₓSeₓ, where x ranges between 0 and 0.60. This list is not intended to be exhaustive, and other suitable chalcogenide glasses can be used to form the layers 152 and 156 in FIG. 3.

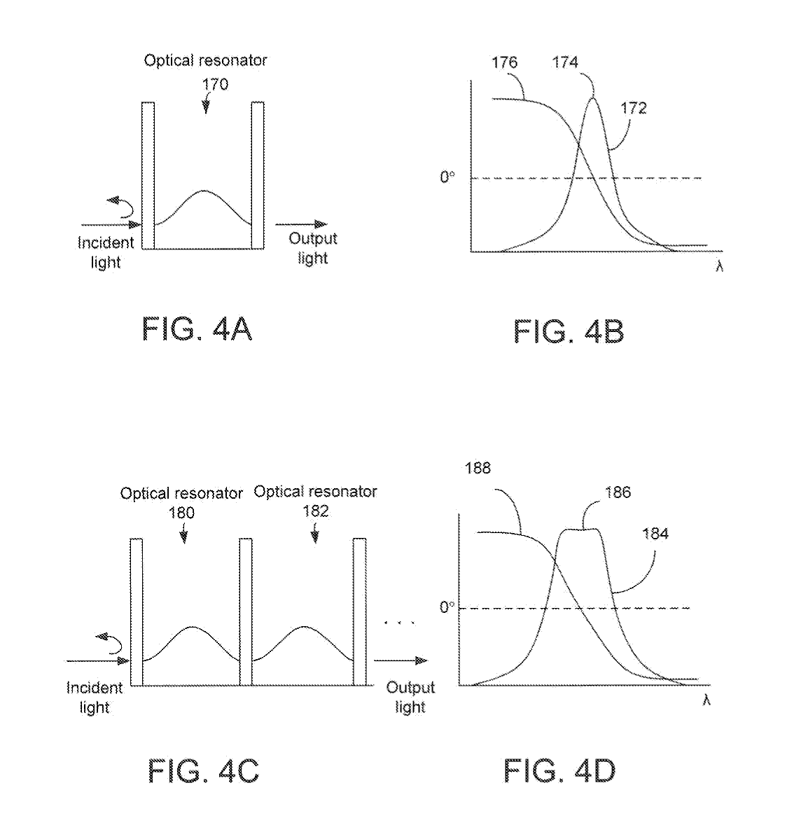

The operating principle of adjusting the phase of light by means of the coupled optical resonators is now described with reference to FIGS. 4A-4D. Generally, an optical resonator 170 as shown in FIG. 4A typically has a single transmission peak 174 in its transmission curve 172, shown in FIG. 4B, which occurs when the optical path length of the optical resonator 170 equals half of the wavelength of the incident light. The transmission peak 174 of the single optical resonator 170 is relatively narrow, and the transmission falls off rapidly as the wavelength becomes longer or shorter. The phase of the transmitted light as shown by the phase curve 176 also changes sharply around the transmission peak 174, undergoing a 180-degree change with a zero crossing near the transmission peak.

In accordance with an aspect of embodiments of the invention, two or more optical resonators are coupled together to provide a band-pass-like transmission. FIG. 4C shows two coupled optical resonators 180 and 182, and FIG. 4D shows the transfer function of that combination. The transmission peak wavelengths of the two resonators 180 and 182 are set to be relatively close but with a small offset. As a result, the combined transmission curve 184 of the coupled resonators has a peak 186 that is broader than the transmission peaks of the individual resonators. Due to the flattened top of the transmission peak, the transmission is band-pass in character, even though the band may be narrow. The phase curve 188 of the coupled resonators still changes quickly around the transmission peak, but has become more gradual due to the peak broadening. Although for clarity of illustration. FIG. 4C shows a coupled resonator with two resonators, three or more resonators can also be used to form coupled resonators. Increasing the number of optical resonators in the coupling may have the effects of further broadening the transmission peak and flattening the top of transmission peak, but on the other hand may increase the complexity and cost of fabricating the coupled resonators.

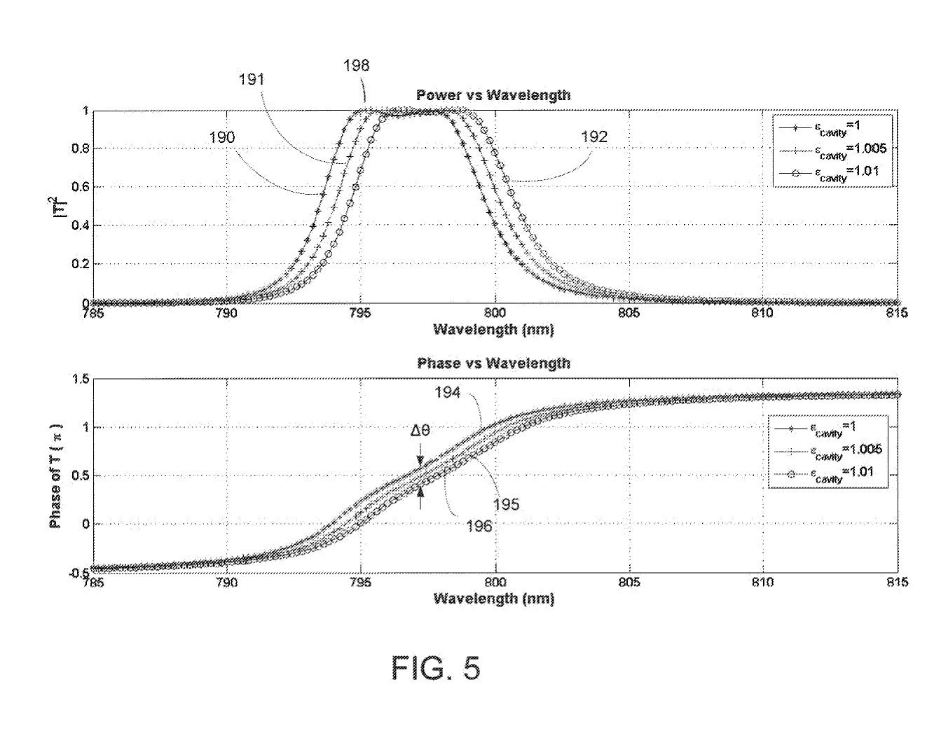

The broadened transmission band of the coupled resonators, in combination with the ability to move the band by altering the optical path lengths of the optical resonators, provides the flexibility of adjusting the phase of the transmitted light independent of its amplitude. FIG. 5 shows simulated data for illustrating this effect. The top panel of FIG. 5 shows three transmission curves 190, 191, 192 of the same set of coupled optical resonators, and the bottom panel shows the corresponding phase curves 194, 195, 196. The three transmission curves correspond to three different values of the index of refraction of the electro-optical material in the optical resonators. As described above, the index of refraction of the electro-optical material may be changed by applying voltages to the electrodes of the resonators, and the change in the index of refraction alters the optical lengths, resulting in a shift of the transmission peak. In the illustrated case, the first transmission curve 190 corresponds to the resonators with no electrical field applied thereto. The second transmission curve 191 corresponds to a 0.5% increase of the index of refraction, and the third transmission curve 192 corresponds to a 1% increase of the index of refraction. An increase in the index of refraction corresponds to an increase in the optical path lengths of the resonators and a shift of the transmission band to a longer wavelength. For a given wavelength, such as 797 nm, however, the transmission amplitude is largely not affected by the shifting of the transmission band 198, due the relatively flat top of the transmission band. In contrast, the phase angle of the transmitted light depends on the position of the wavelength within the transmission band. When the band is shifted, the phase angle of the transmitted light changes to a different value, even though the amplitude of the transmitted light remains substantially the same. By way of example, in FIG. 5, the phase angle at 797 nm shifts by Δθ from the value on the phase curve 194 for unbiased resonators, when the index of refraction is increased by 1%. It should be noted that it is this relative angle change, Δθ, rather than the absolute value of the phase angle, that represents the phase angle adjustment that can be imparted onto the light transmitted through the coupled optical resonators.

As mentioned earlier in connection with FIG. 2, a separate amplitude adjustment component, such as an LCD cell, may be used to provide amplitude control for a pixel for sub-pixel. In combination, the coupled optical resonators and the amplitude control component allow independent adjustments of the phase and amplitude of transmitted light on a pixel-by-pixel basis. Referring back to FIG. 1, the light source 108 provides a coherent light with a wavelength that falls within the pass bands of the coupled optical resonators of the pixels in the display device 102. To display a holographic image 101, the controller 106 receives information regarding the amplitude and phase for each pixel from the image data source 104. The controller 106 then controls each pixel of the display device 102, such as by applying proper biasing voltages to the optical resonators of the pixel, to impart the desired phase to the light transmitted through that pixel. Similarly, the controller 106 controls the amplitude adjustment component of the pixel to obtain the desired amplitude of transmitted light. As both the phase and amplitude controls can be performed at relatively high speeds, the display system 100 can be used to display dynamically changing images, such as consecutive video frames. Moreover, as mentioned above, due to the compact construction of the optical resonators, the pixels of the display may be formed to have dimensions less than the wavelength of the light used for the 3D display to provide sub-wavelength display resolution.

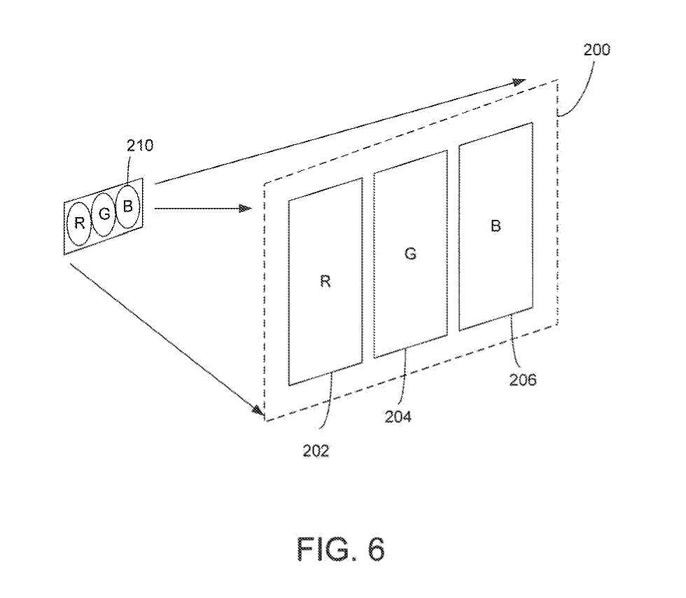

In the foregoing description, the use of coupled optical resonators for phase adjustment for a given light wavelength has been described in detail. One set of such coupled optical oscillators may be sufficient for each pixel of a display device, if the 3D holographic image to be generated is monochromatic, i.e., of a single color. Nevertheless, the same principle can be implemented to display color holographic images. By way of example, FIG. 6 shows an embodiment in which each pixel 200 of the display is composed of three sub-pixels 202, 204, 206 for the three primary colors of R, G, B, respectively. Each sub-pixel may have its own coupled optical resonators for phase control and amplitude control element for amplitude control. The sub-pixels may be constructed based on a crossbar structure similar to that described in connection with FIG. 2. Coherent lights in the three primary colors are projected by the light source 210 onto the sub-pixels of the display pixel 200. Each sub-pixel is used to adjust the phase and amplitude of the light of its color. Due to the relatively sharp cutoff of the optical resonators, resonators of the sub-pixel for one primary color should have very low transmission for the other two primary colors (i.e., small cross-talk). Nevertheless, to ensure maximal separation of the colors, suitable color filters may be disposed before the optical resonators of the sub-pixels so that only the desired primary color will enter the coupled optical resonators of the sub-pixel for that color.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A display device for displaying holographic images, comprising:
a plurality of pixels, each pixel having at least two coupled optical resonators each containing an electro-optical material, and electrodes for applying voltages to the optical resonators for tuning optical lengths of the coupled optical resonators for adjusting a phase shift imparted on light transmitted through the coupled optical resonators.

2. A display device as in claim 1, wherein each pixel further includes an amplitude adjustment component for adjusting an amplitude of light transmitted through the pixel.

3. A display device as in claim 1, wherein the electro-optical material has an index of refraction variable according to an applied electric field.

4. A display device as in claim 3, wherein the electro-optical material is selected from the group of LiNbO₃, PbLaZrTiO₃, LiTaO₃, III-V semiconductors and compounds thereof, II-VI semiconductors and compounds thereof, and chalcogenide glasses.

5. A display device as in claim 1, wherein each pixel has three sub-pixels corresponding to three primary colors, each sub-pixel having at least two coupled optical resonators tuned for a corresponding primary color.

6. A display device as in claim 1, wherein the electrodes form a crossbar structure.

7. A display device as in claim 6, wherein the electrodes include a first group of electrodes and a third group of electrodes running in a first direction, and a second group of electrodes running in a second direction and intersecting the electrodes in the first and second groups to form a plurality of intersections, wherein at each intersection a first layer of an electro-optical, material is placed between an electrode of the first group and an electrode of the second group to form a first optical resonator, and a second layer of the electro-optical material is placed between the electrode of the second group and an electrode of the third group to form a second optical resonator.

8. A display device as in claim 7, wherein each of the electrodes in the first, second, and third groups has a plurality of apertures formed therein for passing light into the first and second optical resonators at each intersection.

9. A display device as in claim 1, further including a light source for generating a coherent light for illuminating the pixels.

10. A display device for displaying holographic images, comprising:
a first layer of electrodes and a third layer of electrodes extending in a first direction;
a second layer of electrodes disposed between the first and third layers of electrodes and extending in a second direction to form a plurality of intersections with the electrodes of the first and third layers, each intersection having a first optical resonator comprising a first layer of an electro-optical material between an electrode of the first layer and an electrode of a second layer, and a second optical resonator comprising a second layer of the electro-optical material disposed between the electrode of the second layer and an electrode of the third layer, wherein the first and second optical resonators have tunable optical lengths and are coupled to provide a band-pass transmission of light.

11. A display device as in claim 10, wherein the electro-optical material has an index of refraction variable according to an electric field applied thereto.

12. A display device as in claim 11, wherein the electro-optical material is selected from the group of LiNbO₃, PbLaZrTiO₃, LiTaO₃, III-V semiconductors and compounds thereof, II-VI semiconductors and compounds thereof, and chalcogenide glasses.

13. A display device as in claim 10, further including an amplitude adjustment layer having amplitude adjusting components for adjusting an amplitude of light transmitted through the optical resonators at each intersection.

14. A display device as in claim 13, further including a light source for producing a coherent light for illuminating the optical resonators at the intersections.

15. A method of generating a holographic image, comprising:
projecting a coherent light onto a display device having a plurality of pixels;
controlling each pixel in the display device to adjust a phase and an amplitude of light transmitted through the pixel to form a portion of the holographic image.
